(19) United States
(12) Patent Application Publication
(10) Pub. No.: US 2020/0042711 A1
(43) Pub. Date: Feb. 6, 2020

(54) METHOD FOR STARTING TRUSTED EMBEDDED PLATFORM BASED ON TPM INDUSTRIAL CONTROL

(71) Applicant: SHENYANG INSTITUTE OF AUTOMATION,CHINESE ACADEMY OF SCIENCES, Shenyang, Liaoning (CN)

(72) Inventors: Haibin YU, Shenyang, Liaoning (CN); Peng ZENG, Shenyang, Liaoning (CN); Wenli SHANG, Shenyang, Liaoning (CN); Jianming ZHAO, Shenyang, Liaoning (CN); Xianda LIU, Shenyang, Liaoning (CN); Long YIN, Shenyang, Liaoning (CN); Chunyu CHEN, Shenyang, Liaoning (CN)

(21) Appl. No.: 16/316,269

(22) PCT Filed: May 7, 2018
(86) PCT No.: PCT/CN2018/085765

§ 371 Date: Jan. 8, 2019

(30) Foreign Application Priority Data
Sep. 19, 2017 (CN) 201710845620.9

(51) Int. Cl. G06F 21/57; G06F 9/4401

(52) U.S. Cl. CPC G06F 21/575; G06F 2221/034; G06F 9/4401; G06F 21/572

(57) ABSTRACT

A method for starting a trusted embedded platform based on TPM industrial control includes taking a Core Root of Trust Measurement (CRTM) as a source of a trust chain and executing CRTM after electrifying an embedded platform; conducting trust measurement of BIOS and starting BIOS after passing measurement; BIOS measuring Bootloader and extending a measured value into PCR corresponding to TPM; after passing the measurement, transferring a control execution right to Bootloader; and Bootloader measuring OS kernel start process, recording a measured value into PCR of TPM, and executing a start flow of OS after passing the measurement. The method performs measurement before start of each part of a start process, and measured values are also stored in the PCR corresponding to TPM. When the start process is tampered by an attacker, an integrity measurement mechanism terminates the execution of a program, thereby ensuring the security of the embedded platform.

### TECHNICAL FIELD

The present invention relates to a method for starting a trusted embedded platform based on TPM industrial control, ensures security and trust of an industrial embedded platform, and belongs to the technical field of information security of industrial systems.

### BACKGROUND

Due to the rapid development of information technology and the acceleration of industrialization process driven by the information technology, more and more network communication technologies, computer technologies and embedded technologies are applied to industrial control systems. With the application of these high and new technologies, the security problem of the industrial control systems is also caused, such as information leakage and tampering, viruses, etc. On Sep. 14, 2010, Iran's nuclear facilities were suddenly attacked by a “super virus” called Stuxnet, causing that the nuclear facilities are unable to operate normally. At this point, information security of the industrial control systems has aroused high attention in the industrial community.

The security threats of the information of the industrial control systems mainly come from internal terminal security threats and external network security threats. The internal terminal security threats are mainly reflected in the vulnerability of the platform: the vulnerability of the industrial control systems is generally caused by system defects, wrong configuration or faulty operation for device platform (including hardware, an operating system and application programs of the industrial control systems); proper cipher management mechanisms are absent; and unreasonable access control mechanisms are used. The external network security threats are reflected in the vulnerability of industrial control system networks: defects of the industrial control system networks and other networks connected therewith, wrong configuration or vulnerability of the industrial control systems possibly caused by imperfect network management process. The process of starting a computer by BIOS is divided into two stages: hardware start and operating system start. The process of starting and initializing the hardware by BIOS is relatively closed and secure, while the stage of starting the operating system is relatively complicated and diversified. Users can choose to start the operating system from a hard disk, a floppy disk or from other media. The diversity of operating system start brings many risks for computer data security and access control, The system is susceptible to unauthorized tamper or destruction.

Trusted computation has broad development prospects. Domestic and foreign scholars make numerous researches on the application of trusted computation in the industrial field. However, for special application demands of industrial measurement and control systems, it is necessary to improve a trusted computation method to meet the complex features of the industrial information field. Therefore, to ensure the security of programmable embedded electronic devices, the integrity of the embedded platform should be ensured. Namely, it is necessary to ensure that the information is not intercepted externally through software and that malicious codes do not intercept the control right at one link of a start sequence. The purpose of trusted start is to ensure the integrity of the start process of the operating system. In the start process of the system, a trusted platform module (TPM) successively measures the integrity of a guidance loading program, an operating system kernel and system configuration files, and establishes a trust chain. Before a next link is loaded, the integrity of the next link is measured at first. When the integrity of one link is destructed, system will not be started.

### SUMMARY

In view of the above technical defects, the purpose of the present invention is to provide a method and system for starting a trusted embedded platform based on TPM industrial control. The present invention uses a development board that integrates XC7Z015 chips as an embedded platform, and mainly studies how to apply a trusted computing technology to an industrial embedded system to build a secure and trusted embedded development environment.

A technical solution adopted in the present invention to solve the technical problem is as follows: a method for starting a trusted embedded platform based on TPM industrial control comprises the following steps:

first step: taking a Core Root of Trust Measurement (CRTM) as a source of a trust chain and executing CRTM after electrifying an embedded platform;

second step: conducting trust measurement of BIOS and starting BIOS after passing measurement;

third step: BIOS measuring Bootloader and extending a measured value into PCR corresponding to TPM; after passing the measurement, transferring a control execution right to Bootloader; and

fourth step: Bootloader measuring OS (operating system) kernel start process, recording a measured value into PCR of TPM, and executing a start flow of OS after passing the measurement.

BIOS is used as CRTM.

CRTM writes configuration information of a guidance loading program Bootloader into a measurement log.

The measurement is realized through SHA-1 algorithm.

The measured value is a hash value obtained by using the SHA-1 algorithm and is stored in a platform status register in TPM.

The measured value is a hash value with fixed length.

The measured value is a hash value of 160 bits.

Passing measurement means that the measured value is consistent with the measured value reflected in PCR.

A system for starting a trusted embedded platform based on TPM industrial control comprises:

a CRTM module used for taking CRTM as a source of a trust chain and executing CRTM after electrifying an embedded platform; and

a trusted platform module (TPM) used for conducting trust measurement of BIOS and starting BIOS after passing measurement, wherein BIOS measures Bootloader and extends a measured value into PCR corresponding to TPM; after passing the measurement, a control execution right is transferred to Bootloader; and Bootloader measures OS kernel start process, records a measured value into PCR of TPM, and executes a start flow of OS after passing the measurement.

The present invention has the following beneficial effects and advantages:

1. The present invention performs measurement before start of each part of a start process, and measured values are also stored in the PCR corresponding to TPM. When the start process is tampered by an attacker, an integrity measurement mechanism terminates the execution of a program, thereby ensuring the security of the embedded platform.

2. The present invention realizes a security starting mechanism of an embedded platform using a trusted computing technology in combination with the characteristics of an embedded device on the premise of not changing the existing hardware device architecture.

### DESCRIPTION OF DRAWINGS

FIG. 1 is a structural schematic diagram of a mainboard of an embedded platform based on TPM in the present invention.

FIG. 2 is a functional block diagram of a trusted embedded platform based on TPM in the present invention.

FIG. 3 is a schematic diagram of a transmission process of a trust chain of an embedded trusted platform based on TPM in the present invention.

FIG. 4 is a flow chart of integrity verification of a start process of a trusted embedded platform based on TPM in the present invention.

### DETAILED DESCRIPTION

The present invention will be further described in detail below in combination with embodiments.

The present invention provides a design method for a trusted embedded platform based on TPM industrial control. The method designs an embedded trusted computing platform based on a trusted platform module (TPM) on the foundation of a trusted computing technology, and analyzes transmission mechanisms of the trusted platform module and a trust chain from software structure and hardware structure. The method realizes the trusted mechanism mainly through three roots of trust: a root of trust for measurement (RTM), a root of trust for storage (RTS) and a root of trust for reporting (RTR). Finally, the method conducts trusted verification on a ZYNQ hardware platform, and verifies the correctness of the design method through kernel counterfeit attack tests, thereby ensuring security and trust of an industrial embedded platform.

The method is realized through three roots of trust. RTM is a starting point of trust measurement and establishes trust in the measurement process. RTS is a digest value and sequential computation engine for accurately recording complete measurement, and is a storage unit capable of conducting reliable encryption. RTR is a computation engine that reliably reports RTS, and can reliably report information and identify credibility of platform identity. The core of TPM for assessing a start sequence is a trust chain mechanism. The specific implementation process is as follows:

First step: the CRTM is taken as a source of a trust chain after electrifying an embedded platform, and the system firstly executes codes of CTRM.

Second step: the system firstly conducts trust measurement of BIOS starting from the roots of trust and then starts BIOS after passing measurement.

Third step: BIOS measures Bootloader and extends a measured value into PCR corresponding to TPM; after BIOS completes measurement of Boot loader and passes the measurement, a control execution right is transferred to Bootloader.

Fourth step: Bootloader measures OS (operating system) kernel start process, records a measured value into PCR of TPM, and executes a start flow of OS after passing the measurement.

A trust chain means that this link assesses security of a next link on the premise of trusting a current link, and after it is determined that the next link is trusty, the control right is transferred to the next link, thereby expanding to the whole embedded platform.

In the start process of the system, a measurement digest value of each execution program in the sequence before execution shall be stored into PCR.

Status information of the platform is placed in a measurement log file outside TPM in the form of a log.

The platform status register can store information of 160 bits, and hash values obtained using SHA-1 algorithm are stored. SHA-1 generates an output result (hash value) with fixed length (160 bits) for input messages of any length.

As shown in FIG. 4, the present invention comprises:

1) Initialization stage: in the start process of the system, CRTM initializes an execution program after the system is started, and then guides TPM.

2) Measurement stage: CRTM writes configuration information of a guidance loading program Bootloader into a measurement log, then measures BootLoader and next extends a measured value into PCR corresponding to TPM.

3) If the measurement log is consistent with the measured value reflected in PCR, it indicates that Bootloader is trusty; the control right is transferred to Bootloader, and next stage of measurement is conducted; and if measurement fails, repeated measurement is conducted by returning to 2).

TPM can be regarded as a complete computer which comprises a processor, a coprocessor, a storage unit, an operating system, etc. TPM has four primary functions: symmetrical/asymmetric encryption, secure storage, integrity measurement and signature authentication. Asymmetric encryption and signature authentication of data are realized through the RSA algorithm. Integrity measurement is completed through high efficiency SHA-1 hash algorithm.

The functions of all modules are encapsulated in the form of soft IP core in combination with the characteristic of dynamic reconfiguration of ZYNQ XC7Z015 and TPM architecture proposed by TCG. Meanwhile, logic IP and ZYNQ seamless migration may be realized through AXI4 bus and LMB bus. Finally, a complete trusted embedded SOC system is constituted. Basic composition units of the trusted embedded SOC system comprise a processor, a coprocessor, a storage unit, I/O, etc.

PCR value and the hash values of the configuration information in a guidance sequence are stored into the platform configuration register (PCR) in the chip. Once the platform is started, the data is encapsulated at the current PCR value; and only when the PCR value is the same as the encapsulated value of the data, the data is de-encapsulated. If an abnormal system is started, because the PCR value cannot be matched, the data cannot be de-encapsulated, so as to protect the data security.

A trust chain means that this link assesses security of a next link on the premise of trusting a current link, and after it is determined that the next link is trusty, the control right is transferred to the next link, thereby expanding to the whole embedded platform.

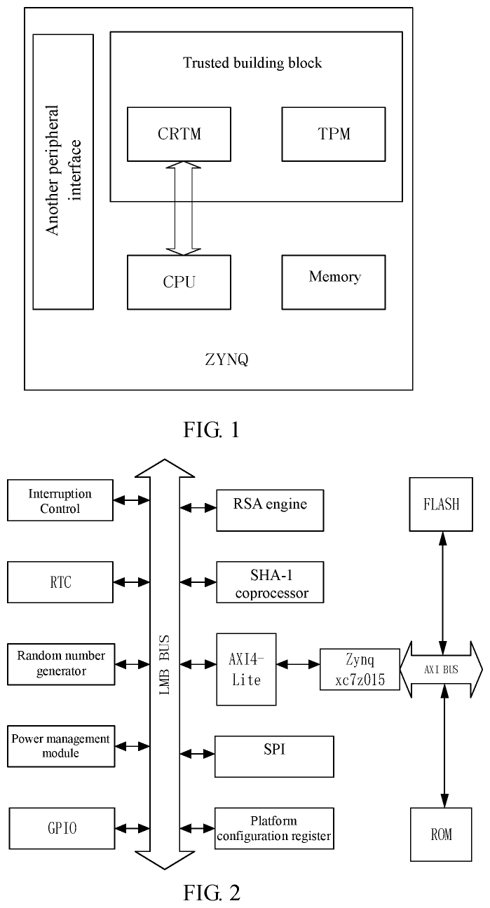

With respect to information security protection needs of industrial measurement and control systems, in order to break through key technologies of development of programmable embedded electronic devices and security protection of operating stage and enhance the security of the programmable embedded electronic devices, the present invention provides a design method for a trusted embedded platform based on TPM industrial control. FIG. 1 shows a mainboard structure of a trusted embedded platform based on TPM in the present invention. FIG. 2 shows a flow chart and structure of a basic model of the method. In specific implementation, the method of the present invention comprises the following major working flows:

step 1: BIOS is used as the Core Root of Trust Measurement (CRTM); the CRTM and the trusted platform module (TPM) form a trusted building block, so that not only the CRTM is protected, but also problems caused by difference of CPU systems are solved.

Step 2: the functions of all modules of the TPM are encapsulated in the form of soft IP core; as shown in FIG. 2, meanwhile, seamless migration of logic IP and ZYNQ processor may be realized through AXI4 bus and LMB bus; and finally, a complete trusted embedded SOC system is constituted. Basic composition units of the trusted embedded SOC system comprise a processor, a coprocessor, a storage unit, I/O, etc.

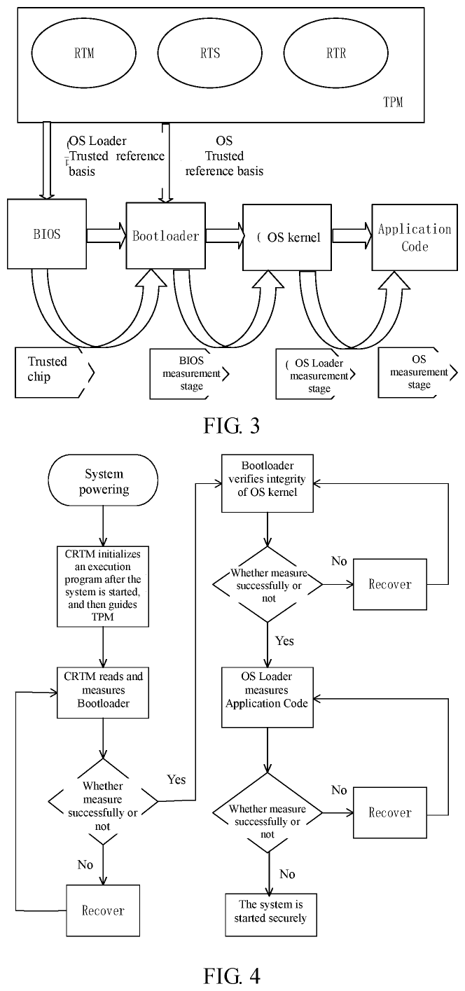

Step 3: TPM successively measures integrity of BIOS, a guidance program, an operating system kernel and an application program and establishes a trust chain. As shown in FIG. 3, before a next link is loaded, the integrity of the next link is measured at first. When the integrity of one link is destructed, system returns this link to a previous level for repeated measurement.

If an untrusted kernel similar to a secure and legal kernel is counterfeited, the kernel illegally tampers the mandatory access control function of a legal start kernel to destruct the integrity of codes and data of the operating system kernel. In the start process of XC7Z015 embedded platform, before Bootloader transfers the control right to OS kernel, the fact that OS kernel is tampered can be discovered in time, i.e., the measured value of OS kernel is different from the standard PCR value, thereby judging that the integrity of the OS kernel is destructed and system start is automatically terminated.

We claim:

1. A method for starting a trusted embedded platform based on TPM industrial control, comprising the following steps:
first step: taking a Core Root of Trust Measurement (CRTM) as a source of a trust chain and executing CRTM after electrifying an embedded platform;
second step: conducting trust measurement of BIOS and starting BIOS after passing measurement;
third step: BIOS measuring Bootloader and extending a measured value into PCR corresponding to TPM; after passing the measurement, transferring a control execution right to Bootloader; and
fourth step: Bootloader measuring OS (operating system) kernel start process, recording a measured value into PCR of TPM, and executing a start flow of OS after passing the measurement.

2. The method for starting the trusted embedded platform based on TPM industrial control according to claim 1, wherein BIOS is used as CRTM.

3. The method for starting the trusted embedded platform based on TPM industrial control according to claim 1, wherein CRTM writes configuration information of a guidance loading program Bootloader into a measurement log.

4. The method for starting the trusted embedded platform based on TPM industrial control according to claim 1, wherein the measurement is realized through SHA-1 algorithm.

5. The method for starting the trusted embedded platform based on TPM industrial control according to claim 1, wherein the measured value is a hash value obtained by using the SHA-1 algorithm and is stored in a platform status register in TPM.

6. The method for starting the trusted embedded platform based on TPM industrial control according to claim 1, wherein the measured value is a hash value with fixed length.

7. The method for starting the trusted embedded platform based on TPM industrial control according to claim 1, wherein the measured value is a hash value of 160 bits.

8. The method for starting the trusted embedded platform based on TPM industrial control according to claim 1, wherein passing measurement means that the measured value is consistent with the measured value reflected in PCR.

9. A system for starting a trusted embedded platform based on TPM industrial control, comprising:
a CRTM module used for taking CRTM as a source of a trust chain and executing CRTM after electrifying an embedded platform; and
a trusted platform module used for conducting trust measurement of BIOS and starting BIOS after passing measurement, wherein BIOS measures Bootloader and extends a measured value into PCR corresponding to TPM; after passing the measurement, a control execution right is transferred to Bootloader; and Bootloader measures OS kernel start process, records a measured value into PCR of TPM, and executes a start flow of OS after passing the measurement.
